(19) United States
(12) Patent Application Publication
(10) Pub. No.: US 2007/0266228 A1
(43) Pub. Date: Nov. 15, 2007

(54) BLOCK-BASED BRANCH TARGET ADDRESS CACHE

(76) Inventors: Rodney Wayne Smith, Raleigh, NC (US); James Norris Dieffenderfer, Apex, NC (US); Thomas Andrew Sartorius, Raleigh, NC (US)

Correspondence Address: QUALCOMM INCORPORATED, 5775 MOREHOUSE DR., SAN DIEGO, CA, 92121, US

(21) Appl. No.: 11/382,527

(22) Filed: May 10, 2006

(51) Int. Cl. G06F 15/00

(52) U.S. Cl. 712/238

(57) ABSTRACT

A Branch Target Address Cache (BTAC) stores a plurality of entries, each BTAC entry associated with a block of two or more instructions that includes at least one branch instruction having been evaluated taken. The BTAC entry includes an indicator of which instruction within the associated block is a taken branch instruction. The BTAC entry also includes the Branch Target Address (BTA) of the taken branch. The block size may, but does not necessarily, correspond to the number of instructions per instruction cache line.

### FIELD

The present disclosure relates generally to the field of processors and in particular to a block-based branch target address cache.

### BACKGROUND

Microprocessors perform computational tasks in a wide variety of applications. Improving processor performance is a design goal, to drive product improvement by realizing faster operation and/or increased functionality through enhanced software. In common embedded applications, such as portable electronic devices, conserving power and reducing chip size are also important goals in processor design and implementation.

Common modern processors employ a pipelined architecture, where sequential instructions, each having multiple execution steps, are overlapped in execution. This ability to exploit parallelism among instructions in a sequential instruction stream contributes to improved processor performance. Under ideal conditions and in a processor that completes each pipe stage in one cycle, following the brief initial process of filling the pipeline, an instruction may complete execution every cycle.

Such ideal conditions are rarely, if at all, realized in practice, due to a variety of factors including data dependencies among instructions (data hazards), control dependencies such as branches (control hazards), processor resource allocation conflicts (structural hazards), interrupts, cache misses, and the like. A major goal of processor design is to avoid these hazards, and keep the pipeline “full.”

Real-world programs may include branch instructions, which may comprise unconditional or conditional branch instructions. The actual branching behavior of branch instructions is often not known until the instruction is evaluated deep in the pipeline. This generates a control hazard that stalls the pipeline, as the processor does not know which instructions to fetch following the branch instruction, and will not know until the branch instruction evaluates. Common modern processors employ various forms of branch prediction, whereby the branching behavior of conditional branch instructions and branch target addresses are predicted early in the pipeline. The processor speculatively fetches and executes instructions, based on the branch prediction, thus keeping the pipeline full. If the prediction is correct, performance is maximized and power consumption minimized. When the branch instruction is actually evaluated, if the branch was mispredicted, the speculatively fetched instructions must be flushed from the pipeline, and new instructions fetched from the correct branch target address. Mispredicted branches adversely impact processor performance and power consumption.

There are two components to a branch prediction: a condition evaluation and a branch target address. The condition evaluation (relevant only to conditional branch instructions, of course) is a binary decision: the branch is either taken, causing execution to jump to a different code sequence, or not taken, in which case the processor executes the next sequential instruction following the conditional branch instruction. The branch target address (BTA) is the address to which control branches for either an unconditional branch instruction or a conditional branch instruction that evaluates as taken. Some branch instructions include the BTA in the instruction op-code, or include an offset whereby the BTA can be easily calculated. For other branch instructions, the BTA is not calculated until deep in the pipeline, and thus must be predicted.

One known technique of BTA prediction is a Branch Target Address Cache (BTAC). A BTAC as known in the prior art is a fully associative cache, indexed by a branch instruction address (BIA), with each data location (or cache “line”) containing a single BTA. When a branch instruction evaluates in the pipeline as taken and its actual BTA is calculated, the BIA and BTA are written to the BTAC (e.g., during a write-back pipeline stage). When fetching new instructions, the BTAC is accessed in parallel with an instruction cache (or I-cache). If the instruction address hits in the BTAC, the processor knows that the instruction is a branch instruction (this is prior to the instruction fetched from the I-cache being decoded) and a predicted BTA is provided, which is the actual BTA of the branch instruction's previous execution. If a branch prediction circuit predicts the branch to be taken, instruction fetching begins at the predicted BTA. If the branch is predicted not taken, instruction fetching continues sequentially.

Note that the term BTAC is also used in the art to denote a cache that associates a saturation counter with a BIA, thus providing only a condition evaluation prediction (i.e., taken or not taken). That is not the meaning of this term as used herein.

High performance processors may fetch more than one instruction at a time from the I-cache. For example, an entire cache line, which may comprise, e.g., four instructions, may be fetched into an instruction fetch buffer, which sequentially feeds them into the pipeline. Patent application Ser. No. 11/089,072, assigned to the assignee of the present application and incorporated herein by reference, discloses a BTAC storing two or more BTAs in each cache line, and indexing a Branch Prediction Offset Table (BPOT) to determine which of the BTAs is taken as the predicted BTA on a BTAC hit. The BPOT avoids the costly hardware structure of a BTAC with multiple read ports, which would be common to access the multiple BTAs in parallel.

Since common groups or blocks of instructions are not made up entirely, or even commonly, of branch instructions, providing separate BTA storage in the BTAC for each instruction in the block wastes memory cells in the BTAC. However, accessing the BTAC when block-fetching instructions to determine whether an instruction in the block is an unconditional branch instruction or a conditional branch instruction having been evaluated taken and obtaining its BTA, is valuable to branch prediction and hence processor performance.

### SUMMARY

According to one or more embodiments, a Branch Target Address Cache (BTAC) stores a plurality of entries, each entry associated with a block of two or more instructions that includes at least one branch instruction having been evaluated as taken (i.e., either an unconditional branch instruction or a conditional branch instruction that was previously evaluated in the pipeline as taken). The BTAC entry includes the Branch Target Address (BTA) of the taken branch, and an indicator of which instruction within the associated block is the branch. The instruction block size may, but does not necessarily, correspond to the number of instructions per instruction cache line. Each BTAC entry is indexed by the common bits of the instructions in the block (i.e., the instruction addresses with the least significant bits truncated).

One embodiment relates to a method of predicting conditional branch instructions in a processor. An entry associated with a block of two or more instructions that includes at least one branch instruction having been evaluated taken is stored in a BTAC. Upon fetching an instruction, the BTAC is accessed to determine if an instruction in the corresponding block is a taken branch instruction.

Another embodiment relates to a processor. The processor includes a BTAC storing a plurality of entries, each BTAC entry associated with a block of two or more instructions that includes at least one branch instruction having been evaluated taken. The processor also includes an instruction execution pipeline operative to index the BTAC with a truncated instruction address upon fetching one or more instructions.

### BRIEF DESCRIPTION OF DRAWINGS

FIG. 1 is a functional block diagram of one embodiment of a processor.

FIG. 2 is a functional block diagram of one embodiment of a Branch Target Address Cache and concomitant circuits.

### DETAILED DESCRIPTION

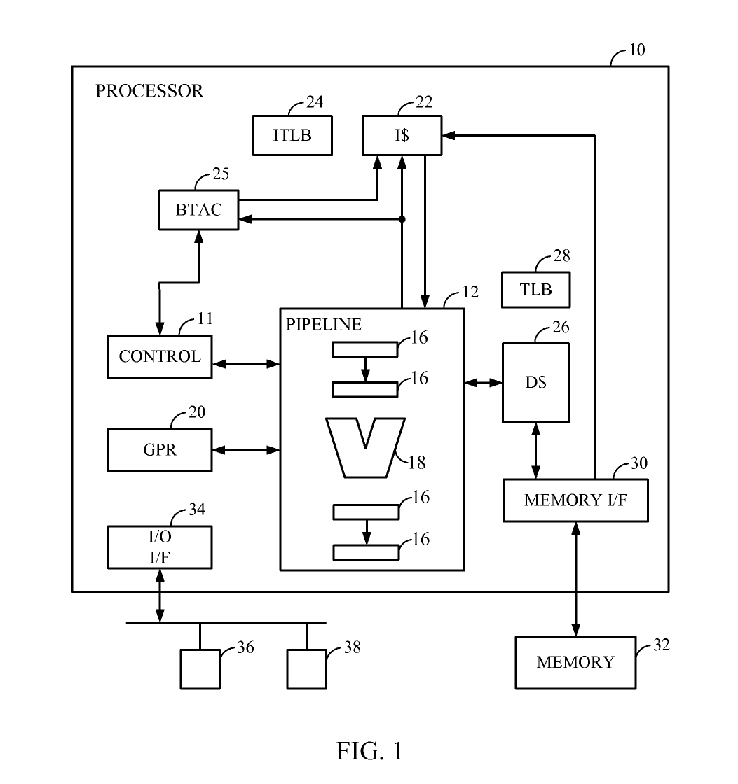

FIG. 1 depicts a functional block diagram of a processor 10. The processor 10 executes instructions in an instruction execution pipeline 12 according to control logic 11. In some embodiments, the pipeline 12 may be a superscalar design, with multiple parallel pipelines. The pipeline 12 includes various registers or latches 16, organized in pipe stages, and one or more Arithmetic Logic Units (ALU) 18. A General Purpose Register (GPR) file 20 provides registers comprising the top of the memory hierarchy.

The pipeline 12 fetches instructions from an instruction cache (I-cache) 22, with memory address translation and permissions managed by an Instruction-side Translation Lookaside Buffer (ITLB) 24. In parallel, the pipeline 12 provides a truncated instruction address to a block-based Branch Target Address Cache (BTAC) 25. If the truncated address hits in the BTAC 25, the BTAC 25 may provide a branch target address (BTA) to the I-cache 22, to immediately begin fetching instructions from a predicted BTA. The structure and operation of the block-based BTAC 25 are described more fully below.

Data is accessed from a data cache (D-cache) 26, with memory address translation and permissions managed by a main Translation Lookaside Buffer (TLB) 28. In various embodiments, the ITLB may comprise a copy of a portion of the TLB. Alternatively, the ITLB and TLB may be integrated. Similarly, in various embodiments of the processor 10, the I-cache 22 and D-cache 26 may be integrated, or unified. Misses in the I-cache 22 and/or the D-cache 26 cause an access to main (off-chip) memory 32, under the control of a memory interface 30.

The processor 10 may include an Input/Output (I/O) interface 34, controlling access to various peripheral devices 36, 38. Those of skill in the art will recognize that numerous variations of the processor 10 are possible. For example, the processor 10 may include a second-level (L2) cache for either or both the I and D caches 22, 26. In addition, one or more of the functional blocks depicted in the processor 10 may be omitted from a particular embodiment.

Branch instructions are common in some code. By some estimates, as common as one in five instructions may be a branch. Accordingly, early branch detection, branch evaluation prediction (for conditional branch instructions), and fetching instructions from a predicted BTA can be critical to processor performance. Common modern processors include an I-cache 22 that stores a plurality of instructions in each cache line. The entire line (or more) may be fetched from the I-cache at one time. For the purpose of this disclosure, assume the I-cache 22 stores four instructions per cache line, although this example is illustrative only and not limiting. To access a prior art BTAC to search against all four instruction addresses in parallel would require four address compare input ports, four BTA output ports, and a multiplexer and control logic to select a BTA from among up to four BTAs associated with the block, if all four addresses hit in the BTAC. While a block of four branch instructions would be rare, the BTAC as taught herein accommodates the possibility.

According to one or more embodiments, a block-based BTAC 25 stores taken branch information associated with a block of instructions (e.g., four) in each BTAC 25 cache line. This information comprises the fact that at least one instruction in the block is a branch instruction having been evaluated taken (indicated by a hit in the block-based BTAC 25), an indicator of which instruction in the block is the taken branch, and its BTA.

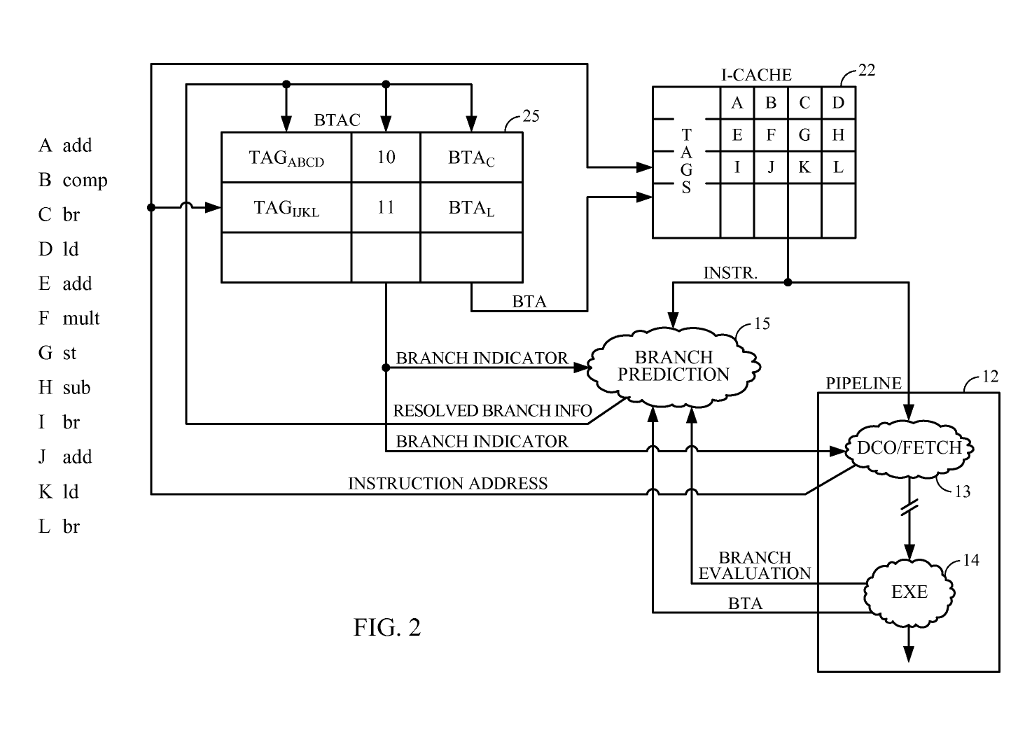

FIG. 2 depicts a functional block diagram of a block-based BTAC 25, I-cache 22, pipeline 12, and branch prediction logic circuit 15 (which may, for example, comprise part of control logic 11). In this example, instructions A-L reside in three lines in the I-cache 22. The instructions are listed to the left of the block diagram. In the block-based BTAC 25 of this example, the BTAC 25 block size corresponds to the I-cache 22 line length—four instructions—although such correspondence is not common. Each entry in the block-based BTAC 25 of FIG. 2 comprises three components: a tag field comprising the common instruction address bits of the four instructions in each block (that is, the instruction address with the two least significant bits truncated), a branch indicator depicting which of the instructions within the block is a taken branch, and a branch target address (BTA) corresponding to the taken branch instruction.

The first entry in the BTAC 25 corresponds to the first line of the I-cache 22, comprising instructions A, B, C, and D. Of these, instruction C is a branch instruction having been evaluated taken. Instruction C is identified as the taken branch by the branch indicator address of 10 (in other embodiments, the branch indicator may be in a decoded format, such as 0010). The block-based BTAC 25 additionally stores the branch target address of instruction C (BTAc).

None of the instructions in the second line of the I-cache 22—E, F, G, or H—is a branch instruction. Accordingly, no entry corresponding to this cache line exists in the block-based BTAC 25.

The second entry in the block-based BTAC 25 corresponds to the third line of the I-cache 22, comprising instructions I, J, K, and L. Within this block, both instructions I and L are branch instructions. In this example, instruction L last evaluated taken, and the block-based BTAC 25 stores BTAL, and identifies the fourth instruction in the block as the taken branch by the branch indicator value of 11.

In operation, decode/fetch logic 13 in the pipeline 12 generates an instruction address for fetching the next group of instructions from the I-cache 22. A truncated instruction address comprising the common address bits of all instructions being fetched simultaneously compares against the tag field of the block-based BTAC 25. If the truncated address matches a tag in the block-based BTAC 25, the corresponding branch indicator is provided to the decode/fetch logic 13 to indicate which instruction in the block is the taken branch instruction. The indicator is also provided to the branch prediction logic 15. Simultaneously, the BTA of the BTAC entry is provided to the I-cache 22, to begin immediate speculative fetching from the BTA, to keep the pipeline full in the event the branch is taken as predicted.

The branch instruction is evaluated in the logic 14 of an execute stage in the pipeline 12. The branch evaluation is provided to the branch prediction logic 15, to update the prediction logic as to the actual branch behavior. The EXE logic 14 additionally computes and provides the BTA of the branch instruction if it evaluates as taken. The branch prediction logic 15 updates its prediction tables (such as a branch history register, branch prediction table, saturation counters, and the like), and additionally updates the block-based BTAC 25. In particular, the branch prediction logic 15 creates a new entry in the block-based BTAC 25, corresponding to a block of four instructions, for each new branch instruction that evaluates as taken, and updates the branch indicator and/or BTA fields of the block-based BTAC 25 for existing entries.

Each entry in the block-based BTAC 25 is thus associated with a block of instructions including at least one branch instruction having been evaluated taken. Each entry includes a tag comprising the common bits of the instructions in the block. By accessing the block-based BTAC 25 in parallel with fetching one or more instructions from the I-cache 22, using a truncated instruction address to compare against the block-based BTAC 25 tags, the processor 10 may ascertain whether any instruction in the block is a taken branch instruction and which instruction in the block it is. Further, the processor 10 may immediately begin speculatively fetching instructions from the BTA of the taken branch, maintaining a full pipeline and optimizing performance where the branch again evaluates taken. The block structure of instructions associated with BTAC entries eliminates three input ports, three output ports, and an output multiplexer that would be required to achieve the same functionality using conventional BTAC entries, each dedicated to a single taken branch instruction.

As used herein, in general, a branch instruction may refer to either a conditional or unconditional branch instruction. As used herein, a “taken branch,” “taken branch instruction,” or “branch instruction having been evaluated taken” refers to either an unconditional branch instruction, or a conditional branch instruction that has been evaluated as diverting sequential instruction execution flow to a non-sequential address (that is, taken as opposed to not taken).

Although the present invention has been described herein with respect to particular features, aspects and embodiments thereof, it will be apparent that numerous variations, modifications, and other embodiments are possible within the broad scope of the present invention, and accordingly, all variations, modifications and embodiments are to be regarded as being within the scope of the disclosure. The present embodiments are therefore to be construed in all aspects as illustrative and not restrictive and all changes coming within the meaning and equivalency range of the appended claims are intended to be embraced therein.

1. A method of predicting branch instructions in a processor, comprising:
storing an entry in a Branch Target Address Cache (BTAC), the BTAC entry associated with a block of two or more instructions that includes at least one branch instruction having been evaluated as taken; and
upon fetching a group of instructions, accessing the BTAC to determine if an instruction in the block corresponding to the fetched instructions is a taken branch instruction.

2. The method of claim 1 wherein each BTAC entry includes a tag comprising the common bits of addresses of the two or more instructions in the block.

3. The method of claim 2 wherein accessing the BTAC comprises comparing corresponding bits of the address of one or more of the group of instructions being fetched to tags of each stored BTAC entry.

4. The method of claim 1 further comprising storing in the BTAC entry an indicator of which instruction within the block is a taken branch instruction.

5. The method of claim 1 further comprising storing in the BTAC entry a Branch Target Address (BTA) of a taken branch instruction within the block.

6. The method of claim 5, further comprising, after accessing the BTAC, fetching instructions from the BTA.

7. The method of claim 1 wherein each instruction block corresponds to an instruction cache line.

8. A processor, comprising:
a Branch Target Address Cache (BTAC) storing a plurality of entries, each BTAC entry associated with a block of two or more instructions that includes at least one branch instruction having been evaluated as taken; and
an instruction execution pipeline operative to index the BTAC with a truncated instruction address upon fetching one or more instructions.

9. The processor of claim 8 wherein the BTAC entry includes a tag comprising common bits of addresses of the two or more instructions in the block.

10. The processor of claim 8 wherein the BTAC entry includes an indicator of which instruction within the block is a taken branch instruction.

11. The processor of claim 8 wherein the BTAC entry includes a Branch Target Address (BTA) of a taken branch instruction within the block.

12. The processor of claim 8 wherein each instruction block corresponds to an instruction cache line.

13. A processor for predicting branch instructions in a processor, comprising:
means for storing an entry in a Branch Target Address Cache (BTAC), the BTAC entry associated with a block of two or more instructions that includes at least one branch instruction having been evaluated taken; and
means for accessing the BTAC to determine if an instruction in the corresponding block is a taken branch instruction upon fetching a group of instructions.

14. The processor of claim 13 wherein the BTAC entry includes a tag comprising common bits of addresses of the two or more instructions in the block.

15. The processor of claim 14 wherein the means for accessing the BTAC comprises a means for comparing corresponding bits of addresses of one or more of the group of instructions being fetched to tags of each stored BTAC entry.

16. The processor of claim 13 further comprising a means for storing in the BTAC entry an indicator of which instruction within the block is a taken branch instruction.

17. The processor of claim 13 further comprising a means for storing in the BTAC entry a Branch Target Address (BTA) of a taken branch instruction within the block.

18. The processor of claim 17, further comprising a means for fetching instructions from the BTA after accessing the BTAC.

19. The processor of claim 13 wherein each instruction block corresponds to an instruction cache line.
